(19) United States
(12) Patent Application Publication
(10) Pub. No.: US 2022/0369278 A1
(43) Pub. Date: Nov. 17, 2022

(54) OBJECT MONITORING METHODS AND APPARATUSES, ELECTRONIC DEVICES AND COMPUTER READABLE STORAGE MEDIA

(71) Applicant: Rajax Network Technology (Shanghai) Co., Ltd., Shanghai (CN)

(72) Inventors: Xiang ZUO, Shanghai (CN); Tian HE, Shanghai (CN)

(21) Appl. No.: 17/767,161

(22) PCT Filed: Sep. 30, 2020
(86) PCT No.: PCT/CN2020/119358

§ 371 Date: Apr. 7, 2022

(30) Foreign Application Priority Data
Oct. 8, 2019 (CN) 201910951476.6

(51) Int. Cl. H04W 64/00; H04W 48/16

(52) U.S. Cl. CPC H04W 64/006; H04W 64/003; H04W 48/16

(57) ABSTRACT

Object monitoring methods and apparatuses, electronic devices, and computer readable storage media are provided. The object monitoring method includes: acquiring WiFi data of a current location of a target object; comparing the WiFi data of the current location with a target location WiFi data list; and in response to a match between the WiFi data of the current location and an item in the target location WiFi data list, generating and reporting target location WiFi monitoring data.

### CROSS-REFERENCE TO RELATED APPLICATIONS

This patent application is the U.S. national phase application of PCT Application No. PCT/CN2020/119358, which claims priority to Chinese patent application No. 2019109514766 entitled “OBJECT MONITORING METHODS AND APPARATUSES, ELECTRONIC DEVICES AND COMPUTER READABLE STORAGE MEDIA”, filed on Oct. 8, 2019, the entire contents of the above-referred applications are incorporated herein by reference.

### TECHNICAL FIELD

The present disclosure relates to the field of information processing technology, and in particular, to object monitoring methods and apparatuses, electronic devices, and computer readable storage media.

### BACKGROUND

With the development of Internet technology, more and more merchants or service providers provide services to users through Internet platforms, and perform distribution through distribution resources. However, it is difficult to accurately acquire the time when the distribution resources arrive at a pickup or delivery location and the time period for which the distribution resources stay at the pickup or delivery location.

### SUMMARY

Embodiments of the present disclosure provide object monitoring methods and apparatuses, electronic devices, and computer readable storage media.

In a first aspect, an embodiment of the present disclosure provides an object monitoring method.

To be specific, the object monitoring method includes:

acquiring WiFi data of a current location of a target object;

comparing the WiFi data of the current location with a target location WiFi data list; and

in response to a match between the WiFi data of the current location and an item in the target location WiFi data list, generating and reporting target location WiFi monitoring data.

In conjunction with the first aspect, in a first implementation manner of the first aspect of the present disclosure, the WiFi data includes at least a WiFi unique identifier and a received signal strength, and the target location WiFi data list includes at least WiFi unique identifiers of one or more target locations.

In conjunction with the first aspect and the first implementation manner thereof, in a second implementation manner of the first aspect of the present disclosure, before comparing the WiFi data of the current location with the target location WiFi data list, the method further includes:

acquiring the target location WiFi data list from a server.

In conjunction with the first aspect and the first implementation manner thereof, in a third implementation manner of the first aspect of the present disclosure, in response to the match between the WiFi data of the current location and the item in the target location WiFi data list, generating and reporting the target location WiFi monitoring data includes:

in response to determining that a WiFi unique identifier of the current location is the same as a WiFi unique identifier in the target location WiFi data list, periodically generating target location WiFi monitoring data; and

sending the target location WiFi monitoring data to a server.

In conjunction with the first aspect and the first implementation manner thereof, in a fourth implementation manner of the first aspect of the present disclosure, in response to the match between the WiFi data of the current location and the item in the target location WiFi data list, generating and reporting the target location WiFi monitoring data includes:

in response to determining that the WiFi data of the current location matches an item in the target location WiFi data list, generating target location WiFi connection data;

in response to detecting that a unique identifier of a connected WiFi changes or a received signal strength is lower than a preset strength threshold, generating target location WiFi disconnection data;

obtaining target location WiFi monitoring data by combining the target location WiFi connection data and the target location WiFi disconnection data; and

sending the target location WiFi monitoring data to a server.

In a second aspect, an embodiment of the present disclosure provides an object monitoring method.

To be specific, the object monitoring method includes:

determining a target location WiFi data list;

sending the target location WiFi data list to a target object terminal; and

in response to receiving target location WiFi monitoring data from the target object terminal, processing the target location WiFi monitoring data, where the target location WiFi monitoring data is generated by the target object terminal in response to that WiFi data of a current location of the target object terminal matches an item in the target location WiFi data list.

In conjunction with the second aspect, in a first implementation manner of the second aspect of the present disclosure, the target location WiFi data list includes at least WiFi unique identifiers of one or more target locations.

In conjunction with the second aspect and the first implement manner thereof, in a second implementation manner of the second aspect of the present disclosure, determining the target location WiFi data list includes:

acquiring historical location WiFi data and candidate location WiFi data of the target object terminal;

comparing the historical location WiFi data with the candidate location WiFi data to determine a number of overlaps between the historical location WiFi data and the candidate location WiFi data, and to determine candidate locations corresponding to candidate location WiFi data with a number of overlaps greater than a preset number threshold as target locations; and

obtaining a target location WiFi data list by combining WiFi data corresponding to the target locations.

In conjunction with the second aspect and the first implement manner thereof, in a third implementation manner of the second aspect of the present disclosure, processing the target location WiFi monitoring data includes one or more of the following: extracting a target location WiFi unique identifier; extracting a target location WiFi connection time; extracting a target location WiFi disconnection time; and calculating a target location WiFi connection time period according to the target location WiFi connection time and the target location WiFi disconnection time.

In conjunction with the second aspect and the first implement manner thereof, in a fourth implementation manner of the second aspect of the present disclosure, the method further includes:

performing preset operations according to a processing result of the target location WiFi monitoring data.

In a third aspect, an embodiment of the present disclosure provides an object monitoring apparatus.

To be specific, the object monitoring apparatus includes:

a first acquiring module configured to acquire WiFi data of a current location of a target object;

a comparing module configured to compare the WiFi data of the current location with a target location WiFi data list; and

a generating module configured to, in response to a match between the WiFi data of the current location and an item in the target location WiFi data list, generate and report target location WiFi monitoring data.

In conjunction with the third aspect, in a first implementation manner of the third aspect of the present disclosure, the WiFi data includes at least a WiFi unique identifier and a received signal strength, and the target location WiFi data list includes at least WiFi unique identifiers of one or more target locations.

In conjunction with the third aspect and the first implement manner thereof, in a second implementation manner of the third aspect of the present disclosure, the apparatus further includes:

a second acquiring module configured to acquire the target location WiFi data list from a server.

In conjunction with the third aspect and the first implement manner thereof, in a third implementation manner of the third aspect of the present disclosure, the generating module includes:

a first generating sub-module configured to, when determining that a WiFi unique identifier of the current location is the same as a WiFi unique identifier in the target location WiFi data list, periodically generate target location WiFi monitoring data; and

a first sending sub-module configured to send the target location WiFi monitoring data to a server.

In conjunction with the third aspect and the first implement manner thereof, in a fourth implementation manner of the third aspect of the present disclosure, the generating module includes:

a second generating sub-module configured to, when determining that the WiFi data of the current location matches an item in the target location WiFi data list, generate target location WiFi connection data;

a third generating sub-module configured to, in response to detecting that a unique identifier of a connected WiFi changes or a received signal strength is lower than a preset strength threshold, generate target location WiFi disconnection data;

a combining sub-module configured to obtain target location WiFi monitoring data by combining the target location WiFi connection data and the target location WiFi disconnection data; and

a second sending sub-module configured to send the target location WiFi monitoring data to a server.

In a fourth aspect, an embodiment of the present disclosure provides an object monitoring apparatus.

To be specific, the object monitoring apparatus includes:

a determining module configured to determine a target location WiFi data list;

a sending module configured to send the target location WiFi data list to a target object terminal; and

a processing module configured to, in response to receiving target location WiFi monitoring data from the target object terminal, process the target location WiFi monitoring data, where the target location WiFi monitoring data is generated by the target object terminal in response to that WiFi data of a current location of the target object terminal matches an item in the target location WiFi data list.

In conjunction with the fourth aspect, in a first implementation manner of the fourth aspect of the present disclosure, the target location WiFi data list includes at least WiFi unique identifiers of one or more target locations.

In conjunction with the fourth aspect and the first implement manner thereof, in a second implementation manner of the fourth aspect of the present disclosure, the determining module includes:

an acquiring sub-module configured to acquire historical location WiFi data and candidate location WiFi data of the target object terminal;

a determining sub-module configured to compare the historical location WiFi data with the candidate location WiFi data to determine a number of overlaps between the historical location WiFi data and the candidate location WiFi data, and to determine candidate locations corresponding to candidate location WiFi data with a number of overlaps greater than a preset number threshold as target locations; and

a combining sub-module configured to obtain a target location WiFi data list by combining WiFi data corresponding to the target locations.

In conjunction with the fourth aspect and the first implement manner thereof, in a third implementation manner of the fourth aspect of the present disclosure, processing the target location WiFi monitoring data includes one or more of the following: extracting a target location WiFi unique identifier; extracting a target location WiFi connection time; extracting a target location WiFi disconnection time; and calculating a target location WiFi connection time period according to the target location WiFi connection time and the target location WiFi disconnection time.

In conjunction with the fourth aspect and the first implement manner thereof, in a fourth implementation manner of the fourth aspect of the present disclosure, the apparatus further includes:

a performing module configured to perform preset operations according to a processing result of the target location WiFi monitoring data.

In a fifth aspect, an embodiment of the present disclosure provides an electronic device, including: a memory and a processor, where the memory stores one or more computer instructions, and where the one or more computer instructions are executed by the processor to implement the object monitoring methods in the first and second aspects.

In a sixth aspect, an embodiment of the present disclosure provides a computer readable storage medium on which computer instructions are stored, where the computer instructions are executed by a processor to implement the object monitoring methods in the first and second aspects.

The technical solutions provided by the embodiments of the present disclosure can include the following beneficial effects:

According to the present disclosure, through WiFi data acquired by target object terminals of target objects such as distribution resources, behavior data such as a time when the target objects arrive at a pickup or delivery location and a time period for which the target objects stay at the pickup or delivery location can be determined, and thereby the distribution resources can be managed. In the present disclosure, the behavior data of the target objects such as the distribution resources can be accurately acquired to realize the effective management of the target objects, thereby effectively improving the service quality of Internet platforms and providing data support for allocation and management of the target objects performing tasks.

It should be understood that the above general description and the following detailed description are only exemplary and explanatory and are not restrictive of the present disclosure.

### BRIEF DESCRIPTION OF THE DRAWINGS

Other features, objects and advantages of the present disclosure will become more apparent from the following detailed description of non-limiting embodiments in conjunction with the drawings, where:

FIG. 1 is a flowchart illustrating an object monitoring method according to an embodiment of the present disclosure.

FIG. 2 is a flowchart illustrating an object monitoring method according to another embodiment of the present disclosure.

FIG. 3 is a flowchart illustrating step S103 of the object monitoring method according to the embodiment in FIG. 1.

FIG. 4 is a flowchart illustrating step S103 of the object monitoring method according to the embodiment in FIG. 1.

FIG. 5 is a flowchart illustrating an object monitoring method according to another embodiment of the present disclosure.

FIG. 6 is a flowchart illustrating step S501 of the object monitoring method according to the embodiment in FIG. 5.

FIG. 7 is a flowchart illustrating an object monitoring method according to another embodiment of the present disclosure.

FIG. 8 is a structural block diagram illustrating an object monitoring apparatus according to an embodiment of the present disclosure.

FIG. 9 is a structural block diagram illustrating an object monitoring apparatus according to another embodiment of the present disclosure.

FIG. 10 is a structural block diagram illustrating a generating module 803 of the object monitoring apparatus according to the embodiment in FIG. 8.

FIG. 11 is a structural block diagram illustrating a generating module 803 of the object monitoring apparatus according to the embodiment in FIG. 8.

FIG. 12 is a structural block diagram illustrating an object monitoring apparatus according to another embodiment of the present disclosure.

FIG. 13 is a structural block diagram illustrating a determining module 1201 of the object monitoring apparatus according to the embodiment in FIG. 12.

FIG. 14 is a structural block diagram illustrating an object monitoring apparatus according to another embodiment of the present disclosure.

FIG. 15 is a structural block diagram illustrating an electronic device according to an embodiment of the present disclosure.

FIG. 16 is a schematic structural diagram illustrating a computer system suitable for implementing an object monitoring method according to an embodiment of the present disclosure.

### DETAILED DESCRIPTION OF THE EMBODIMENTS

Hereinafter, exemplary embodiments of the present disclosure will be described in detail with reference to the drawings, so that those skilled in the art can easily implement them. Also, for the sake of clarity, parts unrelated to describing the exemplary embodiments are omitted from the drawings.

In the present disclosure, it should be understood that terms such as “including”, “comprising” or “having” are intended to indicate the presence of features, numbers, steps, acts, components, parts, or combinations thereof disclosed in the specification and not intended to exclude the possible presence or addition of one or more other features, numbers, steps, acts, components, parts, or combinations thereof.

In addition, it should be noted that the embodiments in the present disclosure and the features in the embodiments may be combined with each other in a case of no conflict. The present disclosure will be described in detail below with reference to the drawings and in conjunction with the embodiments.

With the development of Internet technology, more and more merchants or service providers provide services to users through Internet platforms, and perform distribution through distribution resources. However, it is difficult to accurately acquire the time when the distribution resources arrive at a pickup or delivery location and the time period for which the distribution resources stay at the pickup or delivery location, and thereby, it is difficult to effectively manage the distribution resources, which in turn affects the service quality of the Internet platforms.

The Beacon scheme can be used to solve the above problem. Specifically, a physical or virtual Beacon device is first disposed at a target location, and then monitoring of distribution resources within a monitoring range of the Beacon device is realized by means of an ibeacon Bluetooth protocol. For example, when a mobile terminal of the distribution resources enters the monitoring range of the Beacon device, Beacon information at a current location is acquired, and when it is determined that the Beacon information at the current location is Beacon information at the target location, a current connection time and other behavior information are reported. When the mobile terminal leaves the monitoring range of the Beacon device, a disconnection time and other information are reported, and then a time when the distribution resources arrive at a pickup or delivery location and a time period for which the distribution resources stay at the pickup or delivery location are acquired. The physical Beacon device refers to an independent low-cost Bluetooth hardware device that can continuously emit specific Beacon broadcast signals, and the virtual Beacon device refers to a mobile device such as a mobile phone that can broadcast specific Beacon signals through Bluetooth functions and virtual Beacon software.

However, the above processing scheme has the following shortcomings: 1. it is difficult to deploy the physical Beacon device, and because of the high frequency of merchant relocation, it is also difficult to promote and maintain the physical Beacon device; 2. the virtual Beacon device needs to occupy a mobile device for a long time, so that the cost thereof is relatively high; 3. current statistics show uneven performance and compatibility of Bluetooth technology on different mobile devices, which makes it difficult to be used stably; 4. it is difficult to deploy the Beacon device at a delivery location such as a user side, and therefore, it is difficult to acquire behavior data on distribution resources arriving at the delivery location.

In view of this, the present disclosure provides an object monitoring method. According to the method, through WiFi data acquired by target object terminals of target objects such as distribution resources, behavior data such as a time when the target objects arrive at a pickup or delivery location and a time period for which the target objects stay at the pickup or delivery location can be determined, and thereby the distribution resources can be managed. In the present disclosure, the behavior data of the target objects such as the distribution resources can be accurately acquired to realize the effective management of the target objects, thereby effectively improving the service quality of Internet platforms and providing data support for allocation and management of the target objects performing tasks.

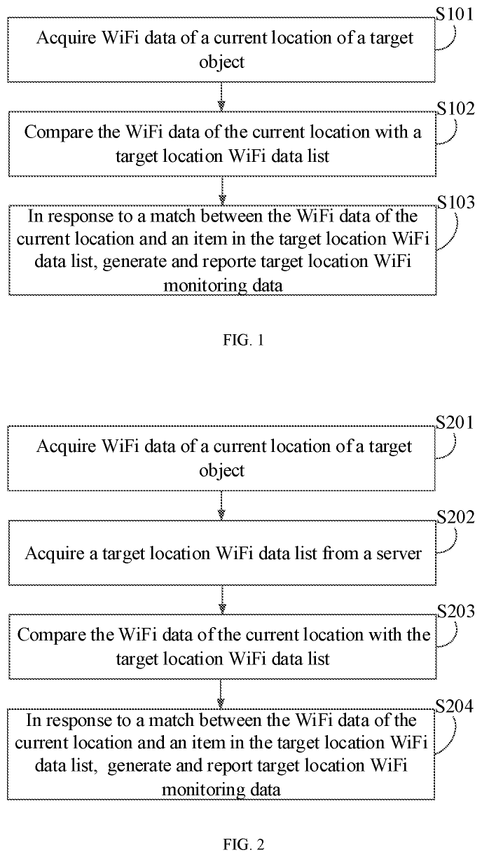

FIG. 1 is a flowchart illustrating an object monitoring method according to an embodiment of the present disclosure, which can be applied to target object terminals of target objects such as distribution resources. As shown in FIG. 1, the object monitoring method includes the following steps S101-S103:

At step S101, WiFi data of a current location of a target object is acquired.

At step S102, the WiFi data of the current location is compared with a target location WiFi data list.

At step S103, in response to a match between the WiFi data of the current location and an item in the target location WiFi data list, target location WiFi monitoring data is generated and reported.

In an example, target objects refer to movable monitored objects such as distribution resources whose preset behavior data needs to be acquired. The preset behavior data may be a time when the target objects arrive at a location, a time when the target objects depart from a location, a time period for which the target objects stay at a location, and the like. Target object terminals are mobile terminals installed with applications related to Internet platforms, such as mobile phones, tablet computers, PDAs, and wearable devices, which can be used by the target objects such as the distribution resources to perform distribution-related operations. Since the target object terminals are carried by the target objects, the target objects and the target object terminals can be regarded as being synchronized in time and space. According to the acquired preset behavior data, the target objects can be managed for a preset purpose.

Considering that WiFi outperforms Beacon in terms of whether stability, generalizability, maintainability, and compatibility, or cost, performance and other aspects, in an example, a target object terminal uses WiFi, that is WirelessFidelity, to acquire behavior data of a target object. WiFi refers to a wireless local area network technology based on an IEEE 802.11 standard, which has a broadcast monitoring function and a unique identifier characteristic. Therefore, in an example, WiFi data includes at least a WiFi unique identifier and a received signal strength.

In an example, the target location refer to a location that is to be monitored and for which an arrival time, a departure time, and a stay time period of the target object are to be acquired. For example, the target locations may be locations where merchants or service providers are, locations where distribution resources are picked up or delivered, or the like.

In order to aggregate and manage WiFi at target locations, and determine whether current locations arrived at by target objects are target locations that are to be monitored, in an example, WiFi data of all target locations are aggregated to form a target location WiFi data list. The target location WiFi data list includes at least WiFi unique identifiers of one or more target locations so as to uniquely and effectively identify and distinguish different target locations. In an example, location information of target locations and WiFi unique identifiers in the target location WiFi data list are stored in a one-to-one correspondence.

In an example, a match between WiFi data of a current location and an item in the target location WiFi data list may be that, for example, a WiFi unique identifier of the current location is the same as a WiFi unique identifier of a target location in the target location WiFi data list, that is, the target location WiFi data list includes target location WiFi data that is the same as the WiFi unique identifier of the current location.

In order to monitor behavior data of target objects, in an example, target location WiFi monitoring data may include one or more of the following data: a target location WiFi connection time, a target location WiFi disconnection time, and the like. A time when the target objects arrive at a target location can be determined according to the target location WiFi connection time. A time when the target objects depart from the target location can be determined according to the target location WiFi disconnection time. A target location WiFi connection duration can be calculated based on the target location WiFi connection time and the target location WiFi disconnection time, and further a time period for which the target objects stay at the target location can be determined.

In an example, before the step S102, that is, before the WiFi data of the current location is compared with the target location WiFi data list, a step of acquiring the target location WiFi data list from a server may be further included. As shown in FIG. 2, the object monitoring method includes the following steps:

At step S201, WiFi data of a current location of a target object is acquired.

At step S202, a target location WiFi data list is acquired from a server.

At step S203, the WiFi data of the current location is compared with the target location WiFi data list.

At step S204, in response to a match between the WiFi data of the current location and an item in the target location WiFi data list, target location WiFi monitoring data is generated and reported.

In an example, a target location WiFi data list is acquired from a server, so that a target object terminal can subsequently determine whether a current location arrived at by a target object is a target location that is to be monitored.

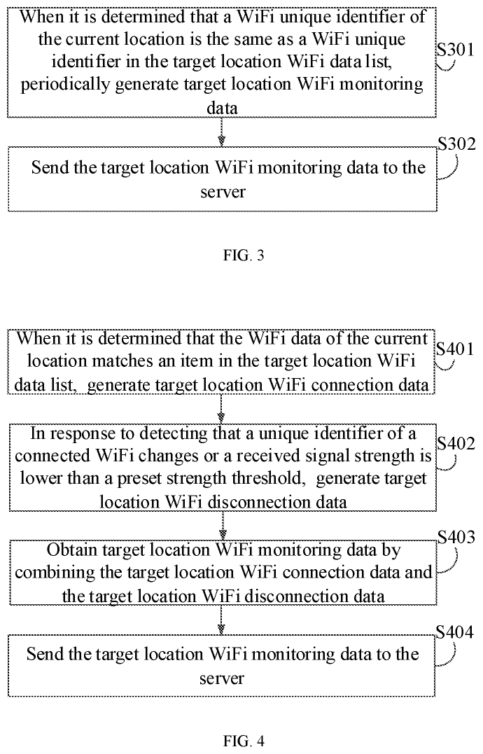

In an example, as shown in FIG. 3, at the step S103, in response to the match between the WiFi data of the current location and the item in the target location WiFi data list, generating and reporting the target location WiFi monitoring data includes the following steps:

At step S301, when it is determined that a WiFi unique identifier of the current location is the same as a WiFi unique identifier in the target location WiFi data list, target location WiFi monitoring data is periodically generated.

At step S302, the target location WiFi monitoring data is sent to the server.

In order to accurately acquire behavior data of a target object such as a target location WiFi connection time and a target location WiFi disconnection time, in an example, when it is determined that a WiFi unique identifier of a current location matches an item in a target location WiFi data list, that is, when a current location arrived at by the target object is a target location where the target object needs to be monitored, a target object terminal can periodically generate target location WiFi monitoring data, and send the target location WiFi monitoring data to a server in time. The frequency at which the target location WiFi monitoring data is generated may be set according to needs of practical applications and accuracy requirements of monitoring data.

In an example, after it is determined that a target object arrives at a target location that is to be monitored at 11:00, target location WiFi monitoring data is generated and sent once every 1 minute, and the target object departs from the target location at 11:20. Therefore, based on the target location WiFi monitoring data sent from 11:00 to 11:20, a time when the target object arrives at the target location, a time when the target object departs from the target location, and a time period for which the target object stays at the target location can be learned.

In an example, when a WiFi unique identifier acquired by a target object terminal changes, WiFi monitoring data received by a server changes, and this time point is determined as a time when a target object departs from a target location. In another example, when a target object terminal does not acquire WiFi data for two consecutive minutes, a server does not receive the WiFi data from the target object terminal for two consecutive minutes, and a time point of a last minute of a current time is determined as a time when a target object departs from a target location.

In an example, only target location WiFi connection data and target location WiFi disconnection data are sent, thereby effectively saving information transmission cost. As shown in FIG. 4, at the step S103, in response to the match between the WiFi data of the current location and the item in the target location WiFi data list, generating and reporting the target location WiFi monitoring data includes the following steps:

At step S401, when it is determined that the WiFi data of the current location matches an item in the target location WiFi data list, target location WiFi connection data is generated.

At step S402, in response to detecting that a unique identifier of a connected WiFi changes or a received signal strength is lower than a preset strength threshold, target location WiFi disconnection data is generated.

At step S403, target location WiFi monitoring data is obtained by combining the target location WiFi connection data and the target location WiFi disconnection data.

At step S404, the target location WiFi monitoring data is sent to the server.

When it is determined that the WiFi data of the current location matches the item in the target location WiFi data list, that is, when a current location arrived at by the target object is a target location where the target object needs to be monitored, target location WiFi connection data is generated to characterize a time when the target object arrives at the target location. Then, real-time detection is performed on the current location WiFi unique identifier or the received signal strength. If it is detected that the current location WiFi unique identifier changes or the received signal strength is lower than the preset strength threshold, it is considered that the target object has departed from the target location. At this time, the target location WiFi disconnection data is generated to characterize a time when the target object departs from the target location. Finally, the target location WiFi monitoring data obtained by combining the target location WiFi connection data and the target location WiFi disconnection data is sent to the server.

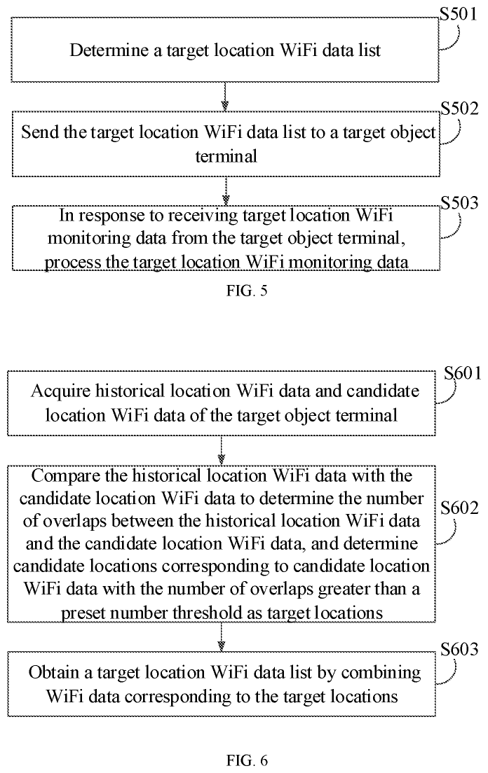

FIG. 5 is a flowchart illustrating an object monitoring method according to another embodiment of the present disclosure, which is applied to a server. As shown in FIG. 5, the object monitoring method includes the following steps:

At step S501, a target location WiFi data list is determined.

At step S502, the target location WiFi data list is sent to a target object terminal.

At step S503, in response to receiving target location WiFi monitoring data from the target object terminal, the target location WiFi monitoring data is processed, where the target location WiFi monitoring data is generated by the target object terminal when WiFi data of a current location of the target object terminal matches an item in the target location WiFi data list.

In an example, a target location WiFi data list includes at least WiFi unique identifiers of one or more target locations. In an example, location information of target locations and WiFi unique identifiers in a target location WiFi data list are stored in a one-to-one correspondence.

In an example, as shown in FIG. 6, at the step S501, determining the target location WiFi data list includes the following steps:

At step S601, historical location WiFi data and candidate location WiFi data of the target object terminal are acquired.

At step S602, the historical location WiFi data is compared with the candidate location WiFi data to determine the number of overlaps between the historical location WiFi data and the candidate location WiFi data, and to determine candidate locations corresponding to candidate location WiFi data with the number of overlaps greater than a preset number threshold as target locations.

At step S603, a target location WiFi data list is obtained by combining WiFi data corresponding to the target locations.

In order to acquire target locations where target objects need to be monitored, historical location WiFi data of locations arrived at by the target objects within a preset historical time period and WiFi data of candidate locations that may become the target locations are first acquired, where the candidate locations may be, for example, locations of some merchants, service providers, and users. These locations may or may not be locations where the target objects need to perform tasks, but locations where other target objects need to perform tasks. Only locations which belong to the target objects that need to perform tasks can be used as the target locations corresponding to the target objects. Then, the historical location WiFi data is compared with the candidate location WiFi data to determine the number of overlaps between the historical location WiFi data and the candidate location WiFi data, and to determine the candidate locations corresponding to the candidate location WiFi data with the number of overlaps greater than the preset number threshold as the target locations, that is, locations where the target objects frequently visit are considered as locations where the target objects need to perform tasks. Finally, the target location WiFi data list is obtained by combining the WiFi data corresponding to the target locations, where the target location WiFi data list may include one or more target locations.

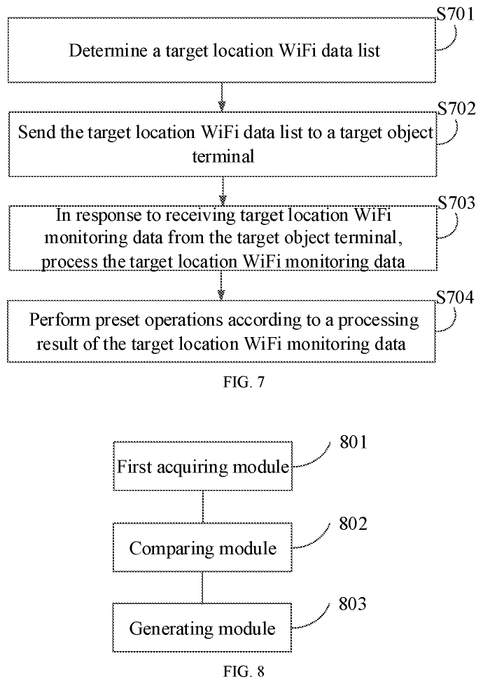

In an example, the method may further include a step of processing the target location WiFi monitoring data, and performing preset operations according to a processing result of the target location WiFi monitoring data. As shown in FIG. 7, the object monitoring method includes the following steps:

At step S701, a target location WiFi data list is determined.

At step S702, the target location WiFi data list is sent to a target object terminal.

At step S703, in response to receiving target location WiFi monitoring data from the target object terminal, the target location WiFi monitoring data is processed, where the target location WiFi monitoring data is generated by the target object terminal when WiFi data of a current location of the target object terminal matches an item in the target location WiFi data list.

At step S704, preset operations are performed according to a processing result of the target location WiFi monitoring data.

In an example, processing the target location WiFi monitoring data may include one or more of the following: extracting a target location WiFi unique identifier, extracting a target location WiFi connection time, extracting a target location WiFi disconnection time, calculating a target location WiFi connection time period according to the target location WiFi connection time and the target location WiFi disconnection time, and so on.

After the processing result of the target location WiFi monitoring data is acquired, the preset operations can be performed according to purposes of practical applications.

In an example, preset operations may include one or more of the following operations: confirming, verifying and correcting behavior of a target object, adjusting a behavior strategy of the target object, and so on.

Taking target objects being distribution resources and target locations being merchant locations as an example, after a time when the distribution resources arrive at the target locations is acquired, if a distribution delay accident occurs on a distribution task corresponding to the distribution resources in that time, according to time when the distribution resources arrive at the target locations, it is determined whether the cause for the distribution delay accident is that an arrival time of the distribution resources is too late or a departure time of the distribution resources from merchants is too late, and thereby it is determined whether the responsibility for the distribution delay accident lies in the distribution resources or the merchants.

After a time period for which the distribution resources stay at the target locations is acquired, a departure time of the distribution resources from the merchants can be predicted according to the time period for which the distribution resources stay, thereby adjusting the allocation strategy of distribution tasks, and improving the distribution quality and efficiency.

Taking target objects being distribution resources and target locations being user locations as an example, after a time when the distribution resources arrive at the target locations is acquired, it can be determined whether the distribution resources are clicked to have been delivered in advance so as to confirm receipt in advance, and delivery times of future distribution tasks can be further predicted according to delivery times of different distribution tasks so as to provide more accurate delivery time prediction services for users, and provide more comprehensive and accurate data support for scheduling of distribution tasks.

Based on the processing result of the target location WiFi monitoring data, the authenticity of target object behavior can be confirmed or verified.

It should be noted that the technical features in the embodiments shown in FIGS. 5-7 are partially the same as or similar to the technical features in the embodiments shown in FIGS. 1-4. For illustration and explanation of the same or similar technical features, reference may be made to the above description, which will not be repeated here.

Below are apparatus embodiments of the present disclosure, which can be used to perform the methods of the present disclosure.

FIG. 8 is a structural block diagram illustrating an object monitoring apparatus according to an embodiment of the present disclosure. The apparatus can be implemented as part or all of an electronic device through software, hardware, or a combination thereof. As shown in FIG. 8, the object monitoring apparatus includes:

a first acquiring module 801 configured to acquire WiFi data of a current location of a target object;

a comparing module 802 configured to compare the WiFi data of the current location with a target location WiFi data list;

a generating module 803 configured to, in response to a match between the WiFi data of the current location and an item in the target location WiFi data list, generate and record target location WiFi monitoring data.

In an example, target objects refer to movable monitored objects such as distribution resources whose preset behavior data needs to be acquired. The preset behavior data may be a time when the target objects arrive at a location, a time when the target objects depart from a location, a time period for which the target objects stay at a location, and the like. Target object terminals are mobile terminals installed with applications related to Internet platforms, such as mobile phones, tablet computers, PDAs, and wearable devices, which can be used by the target objects such as the distribution resources to perform distribution-related operations. Since the target object terminals are carried by the target objects, the target objects and the target object terminals can be regarded as being synchronized in time and space. According to the acquired preset behavior data, the target objects can be managed for a preset purpose.

Considering that WiFi outperforms Beacon in terms of whether stability, generalizability, maintainability, and compatibility, or cost, performance and other aspects, in an example, a target object terminal uses WiFi , that is WirelessFidelity, to acquire behavior data of a target object. WiFi refers to a wireless local area network technology based on an IEEE 802.11 standard, which has a broadcast monitoring function and a unique identifier characteristic. Therefore, in an example, WiFi data includes at least a WiFi unique identifier and a received signal strength.

In an example, the target locations refer to a location that is to be monitored, and for which an arrival time, a departure time, and a stay time period of the target object are to be acquired. For example, the target locations may be locations where merchants or service providers are, locations where distribution resources are picked up or delivered, or the like.

In order to aggregate and manage WiFi at target locations, and determine whether current locations arrived at by target objects are target locations that are to be monitored, in an example, WiFi data of all target locations are aggregated to form a target location WiFi data list. The target location WiFi data list includes at least WiFi unique identifiers of one or more target locations so as to uniquely and effectively identify and distinguish different target locations. In an example, location information of target locations and WiFi unique identifiers in the target location WiFi data list are stored in a one-to-one correspondence.

In an example, a match between WiFi data of a current location and an item in the target location WiFi data list may be that, for example, a WiFi unique identifier of the current location is the same as a WiFi unique identifier of a target location in the target location WiFi data list, that is, the target location WiFi data list includes target location WiFi data that is the same as the WiFi unique identifier of the current location.

In order to monitor behavior data of target objects, in an example, target location WiFi monitoring data may include one or more of the following data: a target location WiFi connection time, a target location WiFi disconnection time, and the like. A time when the target objects arrive at a target location can be determined according to the target location WiFi connection time. A time when the target objects depart from the target location can be determined according to the target location WiFi disconnection time. A target location WiFi connection duration can be calculated based on the target location WiFi connection time and the target location WiFi disconnection time, and further a time period for which the target objects stay at the target location can be determined.

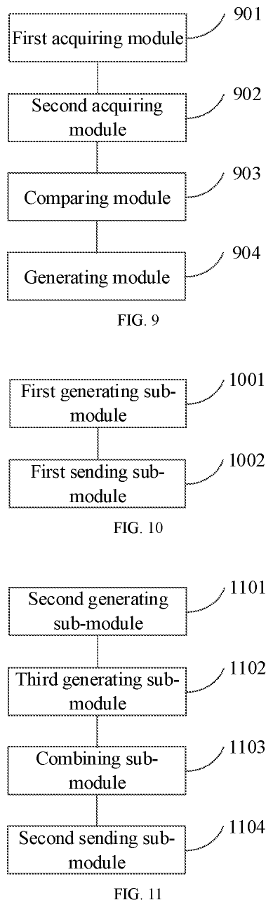

In an example, before the comparing module 802, a module of acquiring the target location WiFi data list from a server may be further included. As shown in FIG. 9, the object monitoring apparatus includes:

a first acquiring module 901 configured to acquire WiFi data of a current location of a target object;

a second acquiring module 902 configured to acquire a target location WiFi data list from a server;

a comparing module 903 configured to compare the WiFi data of the current location with the target location WiFi data list;

a generating module 904 configured to, in response to a match between the WiFi data of the current location and an item in the target location WiFi data list, generate and report target location WiFi monitoring data.

In an example, a target location WiFi data list is acquired from a server, so that a target object terminal can subsequently determine whether a current location arrived at by a target object is a target location that is to be monitored.

In an example, as shown in FIG. 10, the generating module 803 includes:

a first generating sub-module 1001 configured to, when determining that a WiFi unique identifier of the current location is the same as a WiFi unique identifier in the target location WiFi data list, periodically generating target location WiFi monitoring data;

a first sending sub-module 1002 configured to send the target location WiFi monitoring data to the server.

In order to accurately acquire behavior data of a target object such as a target location WiFi connection time and a target location WiFi disconnection time, in an example, when it is determined that a WiFi unique identifier of a current location matches an item in a target location WiFi data list, that is, when a current location arrived at by the target object is a target location where the target object needs to be monitored, the first generating sub-module 1001 can periodically generate target location WiFi monitoring data, and send the target location WiFi monitoring data to a server in time. The frequency at which the target location WiFi monitoring data is generated may be set according to needs of practical applications and accuracy requirements of monitoring data.

In an example, after it is determined that a target object arrives at a target location that is to be monitored at 11:00, target location WiFi monitoring data is generated and sent once every 1 minute, and the target object departs from the target location at 11:20. Therefore, based on the target location WiFi monitoring data sent from 11:00 to 11:20, a time when the target object arrives at the target location, a time when the target object departs from the target location, and a time period for which the target object stays at the target location can be learned.

In an example, when a WiFi unique identifier acquired by a target object terminal changes, WiFi monitoring data received by a server changes, and this time point is determined as a time when a target object departs from a target location. In another example, when a target object terminal does not acquire WiFi data for two consecutive minutes, a server does not receive the WiFi data from the target object terminal for two consecutive minutes, and a time point of a last minute of a current time is determined as a time when a target object departs from a target location.

In an example, only target location WiFi connection data and target location WiFi disconnection data are sent, thereby effectively saving information transmission cost. As shown in FIG. 11, the generating module 803 includes:

a second generating sub-module 1101 configured to, when determining that the WiFi data of the current location matches an item in the target location WiFi data list, generate target location WiFi connection data;

a third generating sub-module 1102 configured to, in response to detecting that a unique identifier of a connected WiFi changes or a received signal strength is lower than a preset strength threshold, generate target location WiFi disconnection data;

a combining sub-module 1103 configured to obtain target location WiFi monitoring data by combining the target location WiFi connection data and the target location WiFi disconnection data;

a second sending sub-module 1104 configured to send the target location WiFi monitoring data to the server.

When it is determined that the WiFi data of the current location matches the item in the target location WiFi data list, that is, when a current location arrived at by the target object is a target location where the target object needs to be monitored, the second generating sub-module 1101 generates target location WiFi connection data to characterize a time when the target object arrives at the target location. The third generating sub-module 1102 performs real-time detection on the current location WiFi unique identifier or the received signal strength. If it is detected that the current location WiFi unique identifier changes or the received signal strength is lower than the preset strength threshold, it is considered that the target object has departed from the target location. At this time, the target location WiFi disconnection data is generated to characterize a time when the target object departs from the target location. The second sending sub-module 1104 sends the target location WiFi monitoring data obtained by combining the target location WiFi connection data and the target location WiFi disconnection data to the server.

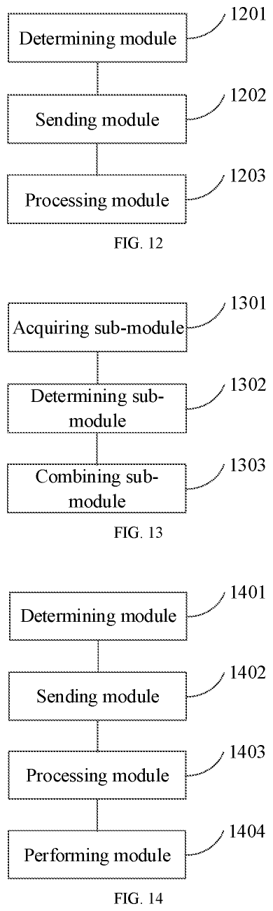

FIG. 12 is a structural block diagram illustrating an object monitoring apparatus according to an embodiment of the present disclosure. The apparatus can be implemented as part or all of an electronic device through software, hardware, or a combination thereof. As shown in FIG. 12, the object monitoring apparatus includes:

a determining module 1201 configured to determine a target location WiFi data list;

a sending module 1202 configured to send the target location WiFi data list to a target object terminal;

a processing module 1203 configured to, in response to receiving target location WiFi monitoring data from the target object terminal, process the target location WiFi monitoring data, where the target location WiFi monitoring data is generated by the target object terminal when WiFi data of a current location of the target object terminal matches an item in the target location WiFi data list.

In an example, a target location WiFi data list includes at least WiFi unique identifiers of one or more target locations. In an example, location information of target locations and WiFi unique identifiers in a target location WiFi data list are stored in a one-to-one correspondence.

In an example, as shown in FIG. 13, the determining module 1201 includes:

an acquiring sub-module 1301 configured to acquire historical location WiFi data and candidate location WiFi data of the target object terminal;

a determining sub-module 1302 configured to compare the historical location WiFi data with the candidate location WiFi data to determine the number of overlaps between the historical location WiFi data and the candidate location WiFi data, and to determine candidate locations corresponding to candidate location WiFi data with the number of overlaps greater than a preset number threshold as target locations;

a combining sub-module 1303 configured to obtain a target location WiFi data list by combining WiFi data corresponding to the target locations.

In order to acquire target locations where target objects need to be monitored, the acquiring sub-module 1301 acquires historical location WiFi data of locations arrived at by the target objects within a preset historical time period and WiFi data of candidate locations that may become the target locations, where the candidate locations may be, for example, locations of some merchants, service providers, and users. These locations may or may not be locations where the target objects need to perform tasks, but locations where other target objects need to perform tasks. Only locations which belong to the target objects that need to perform tasks can be used as the target locations corresponding to the target objects. The determining sub-module 1302 compares the historical location WiFi data with the candidate location WiFi data to determine the number of overlaps between the historical location WiFi data and the candidate location WiFi data, and to determine the candidate locations corresponding to the candidate location WiFi data with the number of overlaps greater than the preset number threshold as the target locations, that is, locations where the target objects frequently visit are considered as locations where the target objects need to perform tasks. The combining sub-module 1303 obtains the target location WiFi data list by combining the WiFi data corresponding to the target locations, where the target location WiFi data list may include one or more target locations.

In an example, the apparatus may further include a module of processing the target location WiFi monitoring data, and performing preset operations according to a processing result of the target location WiFi monitoring data. As shown in FIG. 14, the object monitoring apparatus includes:

a determining module 1401 configured to determine a target location WiFi data list;

a sending module 1402 configured to send the target location WiFi data list to a target object terminal;

a processing module 1403 configured to, in response to receiving target location WiFi monitoring data from the target object terminal, process the target location WiFi monitoring data, where the target location WiFi monitoring data is generated by the target object terminal when WiFi data of a current location of the target object terminal matches an item in the target location WiFi data list;

a performing module 1404 configured to perform preset operations according to a processing result of the target location WiFi monitoring data.

In an example, processing the target location WiFi monitoring data may include one or more of the following: extracting a target location WiFi unique identifier, extracting a target location WiFi connection time, extracting a target location WiFi disconnection time, calculating a target location WiFi connection time period according to the target location WiFi connection time and the target location WiFi disconnection time, and so on.

After the processing result of the target location WiFi monitoring data is acquired, the preset operations can be performed according to purposes of practical applications.

In an example, preset operations may include one or more of the following operations: confirming, verifying and correcting behavior of a target object, adjusting a behavior strategy of the target object, and so on.

Taking target objects being distribution resources and target locations being merchant locations as an example, after a time when the distribution resources arrive at the target locations is acquired, if a distribution delay accident occurs on a distribution task corresponding to the distribution resources in that time, according to time when the distribution resources arrive at the target locations, it is determined whether the cause for the distribution delay accident is that an arrival time of the distribution resources is too late or a departure time of the distribution resources from merchants is too late, and thereby it is determined whether the responsibility for the distribution delay accident lies in the distribution resources or the merchants.

After a time period for which the distribution resources stay at the target locations is acquired, a departure time of the distribution resources from the merchants can be predicted according to the time period for which the distribution resources stay, thereby adjusting the allocation strategy of distribution tasks, and improving the distribution quality and efficiency.

Taking target objects being distribution resources and target locations being user locations as an example, after a time when the distribution resources arrive at the target locations is acquired, it can be determined whether the distribution resources are clicked to have been delivered in advance so as to confirm receipt in advance, and delivery times of future distribution tasks can be further predicted according to delivery times of different distribution tasks so as to provide more accurate delivery time prediction services for users, and provide more comprehensive and accurate data support for scheduling of distribution tasks.

Based on the processing result of the target location WiFi monitoring data, the authenticity of target object behavior can be confirmed or verified.

It should be noted that the technical features in the embodiments shown in FIGS. 12-14 are partially the same as or similar to the technical features in the embodiments shown in FIGS. 8-11. For illustration and explanation of the same or similar technical features, reference may be made to the above description, which will not be repeated here.

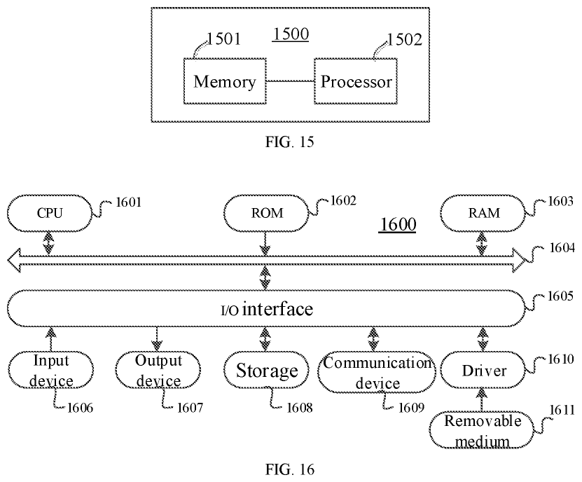

The present disclosure further discloses an electronic device. FIG. 15 is a structural block diagram illustrating an electronic device according to an embodiment of the present disclosure. As shown in FIG. 15, an electronic device 1500 includes a memory 1501 and a processor 1502.

The memory 1501 is used to store one or more computer instructions, where the one or more computer instructions are executed by the processor 1502 to implement the above method steps.

FIG. 16 is a schematic structural diagram illustrating a computer system suitable for implementing an object monitoring method according to embodiments of the present disclosure.

As shown in FIG. 16, a computer system 1600 includes a central processing unit (CPU) 1601, which can execute various processes in the above embodiments according to a program stored in a read only memory (ROM) 1602 or a program loaded into a random access memory (RAM) 1603 from a storage 1608. In the RAM 1603, various programs and data necessary for operation of the system 1600 are also stored. The CPU 1601, the ROM 1602 and the RAM 1603 are connected to each other through a bus 1604. An input/output (I/O) interface 1605 is also connected to the bus 1604.

The following components are connected to the I/O interface 1605: an input device 1606 including a keyboard, a mouse, etc.; an output device 1607 including a cathode ray tube (CRT), a liquid crystal display (LCD), a speaker, etc.; a storage 1608 including a hard disk, etc.; and a communication device 1609 including a network interface card such as an LAN card and a modem. The communication device 1609 performs communication processing via a network such as the Internet. A driver 1610 is also connected to the I/O interface 1605 as needed. A removable medium 1611 such as a magnetic disk, an optical disk, a magneto-optical disk, and a semiconductor memory is installed on the driver 1610 as needed, so that a computer program read therefrom is installed into the storage 1608 as needed.

In particular, according to the embodiments of the present disclosure, the method described above may be implemented as a computer software program. For example, the embodiments of the present disclosure include a computer program product including a computer program tangibly embodied on a readable medium thereof, the computer program including program codes for performing the object monitoring method. In such embodiments, the computer program may be downloaded and installed from the network via the communication device 1609, and/or installed from the removable medium 1611.

The flowcharts and block diagrams in the drawings illustrate architectures, functions, and operations for possible implementation of systems, methods and computer program products according to various embodiments of the present disclosure. In this regard, each block in the flowcharts or block diagrams may represent a module, a program segment, or a portion of codes that contains one or more executable instructions for implementing specified logical functions. It should be noted that, in some alternative implementations, functions labelled in blocks may occur out of the order labelled in the drawings. For example, two blocks shown in succession may, in fact, be executed substantially concurrently, or sometimes be executed in a reverse order, depending upon the functions involved. It should also be noted that each block in the block diagrams and/or flowcharts, and combinations of blocks therein can be implemented by dedicated hardware-based systems that perform specified functions or operations, or by a combination of dedicated hardware and computer instructions.

Units or modules described in the embodiments of the present disclosure can be implemented by software or hardware. The described units or modules may be provided in the processor, and names of these units or modules do not constitute limitations to the units or modules themselves in certain circumstances.

As another aspect, the present disclosure further provides a computer readable storage medium, which can be a computer readable storage medium included in the apparatuses described in the embodiments, or a separate computer readable storage medium not assembled into an apparatus. The computer readable storage medium stores one or more programs used by one or more processors to perform the methods described in the present disclosure.

The above described are only preferred embodiments of the present disclosure and illustration of the applied technical principles. It should be understood by those skilled in the art that the scope of disclosure involved in the present disclosure is not limited to technical solutions formed by specific combinations of the above technical features, and should also cover other technical solutions formed by any combination of the above technical features or their equivalent features without departing from the inventive concept, for example, technical solutions formed by replacing the above features and the technical features with similar functions disclosed in the present disclosure (but not limited thereto) with each other.

What is claimed is:

1. An object monitoring method, comprising:
acquiring WiFi data of a current location of a target object;
comparing the WiFi data of the current location with a target location WiFi data list; and
in response to a match between the WiFi data of the current location and an item in the target location WiFi data list, generating and reporting target location WiFi monitoring data.

2. The object monitoring method of claim 1, wherein the WiFi data comprises at least a WiFi unique identifier and a received signal strength, and the target location WiFi data list comprises at least WiFi unique identifiers of one or more target locations.

3. The object monitoring method of claim 1, wherein before comparing the WiFi data of the current location with the target location WiFi data list, the method further comprises:
acquiring the target location WiFi data list from a server.

4. The object monitoring method of claim 2, wherein in response to the match between the WiFi data of the current location and the item in the target location WiFi data list, generating and reporting the target location WiFi monitoring data comprises:
in response to determining that a WiFi unique identifier of the current location is the same as a WiFi unique identifier in the target location WiFi data list, periodically generating target location WiFi monitoring data; and
sending the target location WiFi monitoring data to a server.

5. The object monitoring method of claim 2, wherein in response to the match between the WiFi data of the current location and the item in the target location WiFi data list, generating and reporting the target location WiFi monitoring data comprises:
in response to determining that the WiFi data of the current location matches an item in the target location WiFi data list, generating target location WiFi connection data;
in response to detecting that a unique identifier of a connected WiFi changes or the received signal strength is lower than a preset strength threshold, generating target location WiFi disconnection data;
obtaining target location WiFi monitoring data by combining the target location WiFi connection data and the target location WiFi disconnection data; and
sending the target location WiFi monitoring data to a server.

6. An object monitoring method, comprising:
determining a target location WiFi data list;
sending the target location WiFi data list to a target object terminal; and
in response to receiving target location WiFi monitoring data from the target object terminal, processing the target location WiFi monitoring data,
wherein the target location WiFi monitoring data is generated by the target object terminal in response to that WiFi data of a current location of the target object terminal matches an item in the target location WiFi data list.

7. The object monitoring method of claim 6, wherein the target location WiFi data list comprises at least WiFi unique identifiers of one or more target locations.

8. The object monitoring method of claim 6 or 7, wherein determining the target location WiFi data list comprises:
acquiring historical location WiFi data and candidate location WiFi data of the target object terminal;
comparing the historical location WiFi data with the candidate location WiFi data to determine a number of overlaps between the historical location WiFi data and the candidate location WiFi data, and to determine candidate locations corresponding to candidate location WiFi data with a number of overlaps greater than a preset number threshold as target locations; and
obtaining a target location WiFi data list by combining WiFi data corresponding to the target locations.

9. The object monitoring method of claim 6 or 7, wherein processing the target location WiFi monitoring data comprises one or more of the following:
extracting a target location WiFi unique identifier;
extracting a target location WiFi connection time;
extracting a target location WiFi disconnection time; and
calculating a target location WiFi connection time period according to the target location WiFi connection time and the target location WiFi disconnection time.

10. The object monitoring method of claim 6, further comprising:
performing preset operations according to a processing result of the target location WiFi monitoring data.

11-20. (canceled)

21. An electronic device, comprising:
a non-transitory memory for storing one or more computer instructions; and
a processor,
wherein when the one or more computer instructions are executed by the processor, the processor is configured to:
acquire WiFi data of a current location of a target object
compare the WiFi data of the current location with a target location WiFi data list and
in response to a match between the WiFi data of the current location and an item in the target location WiFi data list, generate and report target location WiFi monitoring data.

22. (canceled)

23. The electronic device of claim 21, wherein the WiFi data comprises at least a WiFi unique identifier and a received signal strength, and the target location WiFi data list comprises at least WiFi unique identifiers of one or more target locations.

24. The electronic device of claim 21, wherein before comparing the WiFi data of the current location with the target location WiFi data list, the processor is further configured to:
acquire the target location WiFi data list from a server.

25. The electronic device of claim 23, wherein when generating and reporting the target location WiFi monitoring data, the processor is configured to:
in response to determining that a WiFi unique identifier of the current location is the same as a WiFi unique identifier in the target location WiFi data list, periodically generate target location WiFi monitoring data; and
send the target location WiFi monitoring data to a server.

26. The electronic device of claim 23, wherein when generating and reporting the target location WiFi monitoring data, the processor is configured to:
in response to determining that the WiFi data of the current location matches an item in the target location WiFi data list, generate target location WiFi connection data;
in response to detecting that a unique identifier of a connected WiFi changes or the received signal strength is lower than a preset strength threshold, generate target location WiFi disconnection data;
obtain target location WiFi monitoring data by combining the target location WiFi connection data and the target location WiFi disconnection data; and
send the target location WiFi monitoring data to a server.

27. An electronic device, comprising:
a non-transitory memory for storing one or more computer instructions; and
a processor,
wherein when the one or more computer instructions are executed by the processor, the processor is configured to implement an object monitoring method as claimed in claim 6.

28. The electronic device of claim 27, wherein the target location WiFi data list comprises at least WiFi unique identifiers of one or more target locations.

29. The electronic device of claim 27, wherein when determining the target location WiFi data list, the processor is configured to:
acquire historical location WiFi data and candidate location WiFi data of the target object terminal;
compare the historical location WiFi data with the candidate location WiFi data to determine a number of overlaps between the historical location WiFi data and the candidate location WiFi data, and to determine candidate locations corresponding to candidate location WiFi data with a number of overlaps greater than a preset number threshold as target locations; and
obtain a target location WiFi data list by combining WiFi data corresponding to the target locations.

30. The electronic device of claim 27, wherein when processing the target location WiFi monitoring data, the processor is configured to perform one or more of the following:
extracting a target location WiFi unique identifier;
extracting a target location WiFi connection time;
extracting a target location WiFi disconnection time; and
calculating a target location WiFi connection time period according to the target location WiFi connection time and the target location WiFi disconnection time.

31. The electronic device of claim 27, the processor is further configured to:
perform preset operations according to a processing result of the target location WiFi monitoring data.
